(19) United States
(12) Patent Application Publication
(10) Pub. No.: US 2008/0177869 A1
(43) Pub. Date: Jul. 24, 2008

(54) System and method for configuring consumer electronics device for home network using the internet

(76) Inventor: Christopher Jensen Read, San Diego, CA (US)

Correspondence Address: ROGITZ & ASSOCIATES, 750 B STREET, SUITE 3120, SAN DIEGO, CA, 92101, US

(21) Appl. No.: 11/657,366

(22) Filed: Jan. 24, 2007

(51) Int. Cl. G06F 15/177

(52) U.S. Cl. 709/220

(57) ABSTRACT

A consumer electronics (CE) device is connected in a home network to a personal computer (PC) by first connecting them both to an Internet server, which downloads necessary communication information to the devices to allow them to communicate with each other.

### FIELD OF THE INVENTION

The present invention relates generally to systems and methods for configuring consumer electronics (CE) devices for home networks using the Internet.

### BACKGROUND OF THE INVENTION

Connecting consumer electronics (CE) devices to a home network can be a trying experience particularly for non-technical users because networking, simply put, can be quite complicated. Connecting one device in a home network to another typically requires the user to discover and type in IP addresses, user names, perhaps encryption key information, etc., and the process is even more confusing for non-technical users in the case of CE devices such as, e.g., personal video recorders (PVR), digital video disk (DVD) players, and other storage devices that do not have video displays.

As understood herein, methods have been introduced to alleviate the complexity of network set-up, but these methods all have various drawbacks. For example, Dynamic Host Configuration Protocol (DHCP) has been provided for configuring computers with IP addresses, and while DHCP is supported by most home networks, it doesn't exchange enough information to enable device to device communication. Universal Plug and Play (UpNp) is a method that has been provided for discovery and device control in networks, but as understood herein not all PCs support UpNp. Accordingly, the present invention recognizes a need to facilitate ease of connecting CE devices to home networks having PCs.

### SUMMARY OF THE INVENTION

A consumer electronics (CE) device and a personal computer (PC) are placed in the same home network, which is connected to the Internet. The CE device connects to the CE company Internet site, possibly through a home network gateway such as a router. Using its browser, the PC also connects to the same Internet site using its web browser, and necessary configuration programming and information is downloaded from the web site.

Accordingly, a method is disclosed for facilitating communication in a home network between a personal computer (PC) and a consumer electronics (CE) device that is not a PC. The method includes sending from the CE device to an Internet server a serial number and Internet protocol (IP) address of the CE device. The method includes requesting the server to download a registration page to the PC, then entering into the registration page at the PC a serial number of the CE device. A network probing utility is downloaded from the server to the PC, with the utility uploading to the server an IP address and network parameters of the PC. The server is used to provide to the CE device the IP address of the PC and to provide to the PC the IP address of the CE device, whereby the PC and CE device subsequently communicate with each other over the home network.

In non-limiting implementations the CE device does not have a video monitor. The probing utility can upload to the server network parameters of the PC. The network parameters can include a user name. Non-limiting implementations of the method may include sending from the CE device to the server a default gateway associated with the CE device. If desired, information uploaded by the probing utility to the server can be used to compile home network statistics.

In another aspect, a method for facilitating communication in a home network between a personal computer (PC) and a consumer electronics (CE) device that is not a PC includes sending from the CE device to an Internet server at least an network address associated with the CE device. The method also includes sending from the PC to the server at least an address associated with the PC, and using the server to provide to the CE device at least the address of the PC and to provide to the PC at least the address of the CE device, such that the PC and CE device subsequently communicate with each other over the home network.

In another aspect, a server communicating with the Internet executes logic that includes receiving from a non-PC CE device information pertaining to an identity of the CE device and network parameters associated with the CE device. The logic can also include downloading to a PC a probing utility, receiving from the probing utility a network parameters associated with the PC, and based on the network parameters associated with the PC and the network parameters associated with the CE device, providing information to the PC and the CE device to facilitate communication between the PC and CE device.

In yet another aspect, a method for networking a PC with a non-PC CE device in a home includes receiving a serial number and an IP address from a CE device over the Internet, and receiving the same CE device serial number from a PC over the Internet. The method further includes receiving from the PC its IP address and based on the serial number, providing networking information to both the CE device and the PC to enable them to communicate with each other in a home network.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of a non-limiting home network; and

FIG. 2 is a flow chart of non-limiting logic that can be used to establish communications in the home network shown in FIG. 1.

### DETAILED DESCRIPTION OF THE PREFERRED EMBODIMENT

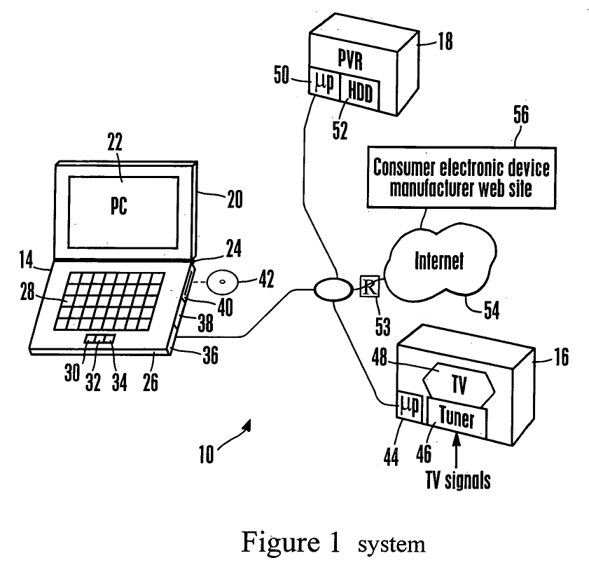

Referring initially to FIG. 1, a system is shown, generally designated 10, which includes a wired or wireless home network 12 that may be implemented by, e.g., Bluetooth, Wi-Fi, Ethernet, power line communications (PLC), or other appropriate networking technology. The network 12 may include components such as a personal computer 14, shown implemented as a laptop or notebook computer although desk top computers can also be used, and one or more non-PC consumer electronic (CE) devices such as but not limited to a TV 16 and a personal video recorder 18 that does not include a video monitor.

Taking the above non-limiting components in order, as shown in FIG. 1 the PC 14 may include a flat screen member 20 holding a computer monitor 22. The flat screen member 20 is connected by a hinge 24 to a flat base member 26. The base member 26 bears an array 28 of computer keys as well as a pointing and clicking device such as but not limited to a touch screen 30 and “left” and “right” entry buttons 32, 34. The computer 14, e.g., the base member 26, can hold a computer processor 36, a solid state storage 38, and one or more disk drives 40 such as but not limited to internal hard disk drives and optical drives for receiving optical disks 42.

In non-limiting implementations the TV 16 may include a TV processor 44 and a TV tuner 46 for receiving TV signals from a source such as a set-top box, cable head end, satellite, etc. for display of video on a video monitor 48. The non-limiting PVR 18 may include a PVR processor 50 and a hard disk drive 52 as shown. The processors 36, 44, 50 shown in FIG. 1 may communicate with each other over the home network 12 through respective communication interfaces, e.g., through Bluetooth interfaces or Wi-Fi interfaces or Ethernet interfaces or PLC interfaces, etc.

Other CE devices include but are not limited to DVD players, removable storage devices, video cassette recorders (VCRs), etc.

As shown in FIG. 1, the home network components 14, 16, 18 may communicate with a gateway 53 such as a router, which in turn communicates over the Internet 54 with a web server 56, also referred to herein as a “web site.” Typically, the home network 12 may communicate with a respective web server associated with the manufacturer of each CE device in the network.

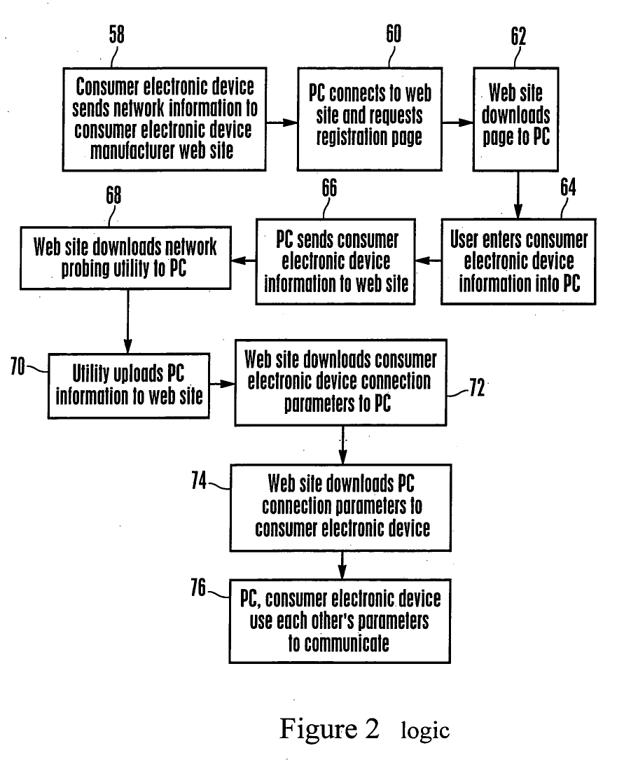

Accordingly and now referring to FIG. 2 for an explanation of one implementation of the present logic for establishing network communication between a CE device 16, 18 and the PC 14, and assuming for convenience that the PVR 18 is the CE device that is sought to be connected to the home network 12, commencing at block 58, the CE device sends its Internet Protocol (IP) address (or, in Ethernet home network implementations, its media access control (MAC) address), default gateway and other network or control parameters such as model number, feature set, control ports, and unique serial number to the CE Internet site or server 56. In this example, the Internet site 56 is associated with the manufacturer of the PVR 18.

Moving to block 60, the PC user operates the browser of the PC 14 to connect to the CE Internet site 56 and request a registration page (by, e.g., clicking on a hyperlink). The page is downloaded from the server 56 to the PC 14 at block 62. At block 64, the user of the PC 14 enters the CE device's serial number into PC 14. The user may also enter the model number of the CE device as well as any necessary initial configuration choices of the CE device. These configuration choices include anything required before the PC begins to talk directly to the CE device over the home network. At block 66 the browser of the PC is used to send the CE device information input at block 64 to the server 56.

Moving to block 68, the server notes the CE device information uploaded by the PC 14 and in response downloads to the PC 14 a computer program referred to herein as a probing utility. At block 70 the utility discovers the PC's IP address and other network parameters such as subnet mask that are relevant to communications with the CE device model and serial number received at block 66, and uploads this information to the server 56.

It may now be appreciated that the server 56 has gained the following information. From the CE device the server 56 has learned the serial number, IP address, and network parameters of the CE device. From the PC the server 56 has verified the serial number and model number of the CE device as well as its configuration choices, and has also learned, by means of the probing utility, the IP address and other network parameters of the PC 14. Accordingly, at block 72 the server 56 (or the probing utility from the PC 14) can look up connection parameters such as port numbers for the particular CE device, as well as the IP address of the CE device, and download these parameters to the PC 14. Moreover, knowing the IP address and connection parameters of the PC the server 56 at block 74 can download this information to the CE device, with the PC 14 and CE device using each other's parameters and addresses to communicate with each other in the home network 12 at block 76. Thus, networking is automatically established in this way, and any further configuration of the CE device can be done directly from the PC after networking is established. This may include downloading of software or web pages from the server 56 to the PC 14 to facilitate that control.

Alternatively, when the gateway 53 is a router that uses only a single IP address to communicate with the Internet to provide a certain level of security, as well as certain services, such as DHCP, at block 58 the CE device need provide only its IP address (or MAC address) to the server 56. Also, since the router hides home networking details from the Internet, the CE device 16, 18 explicitly informs the server 56 of the desired network and control parameters. In the case where the gateway 53 uses a single IP address to communicate with the Internet, only the IP address of the PC need be input at block 64. The server 56 then correlates the PC to the CE device simply by noting that the information each provided was by way of the common IP address used by the gateway 53, and accordingly sends to the PC the address (IP or MAC) of the CE device and likewise sends to the CE device the address (IP or MAC) of the PC.

As understood herein, the invention disclosed above not only promotes ease of network configuration but also provides the added benefit of providing the CE company with statistics of networks in homes, e.g., with various combinations of CE devices and associated networked PCs. The invention is further useful as a tool for a support technician at the Internet site to help someone who has called in with a problem.

While the particular SYSTEM AND METHOD FOR CONFIGURING CONSUMER ELECTRONICS DEVICE FOR HOME NETWORK USING THE INTERNET is herein shown and described in detail, it is to be understood that the subject matter which is encompassed by the present invention is limited only by the claims.

What is claimed is:

1. A method for facilitating communication in a home network between a personal computer (PC) and a consumer electronics (CE) device that is not a PC, comprising:
sending from the CE device to an Internet server at least a network address associated with the CE device;
sending from the PC to the server at least an address associated with the PC;
using the server to provide to the CE device at least the address of the PC; and
using the server to provide to the PC at least the address of the CE device, whereby the PC and CE device subsequently communicate with each other over the home network.

2. The method of claim 1, wherein the CE device does not have a video monitor.

3. The method of claim 1, comprising receiving from the server at least one network probing utility at the PC, the utility uploading to the server at least an IP address of the PC.

4. The method of claim 3, wherein the probing utility uploads to the server network parameters of the PC including at least one user name.

5. The method of claim 1, comprising sending from the CE device to the server at least a default gateway associated with the CE device.

6. The method of claim 1, comprising using information uploaded by the probing utility to the server to compile home network statistics.

7. The method of claim 1, wherein the addresses are IP addresses or MAC addresses.

8. A server communicating with the Internet and executing logic comprising:
receiving from a non-PC CE device information pertaining to an identity of the CE device and network parameters associated with the CE device;
downloading to a PC at least one probing utility;
receiving from the probing utility at least network parameters associated with the PC; and
based at least in part on the network parameters associated with the PC and the network parameters associated with the CE device, providing information to the PC and the CE device to facilitate communication between the PC and CE device.

9. The server of claim 7, wherein the logic includes:
receiving from the PC a request to download a registration page to the PC; and
receiving from the PC by means of the registration page at least a serial number of the CE device.

10. The server of claim 9, wherein the logic includes:
providing to the CE device at least the IP address of the PC; and
providing to the PC at least the IP address of the CE device, whereby the PC and CE device subsequently communicate with each other over the home network.

11. The server of claim 9, wherein the network parameters include at least one user name.

12. The server of claim 9, wherein the logic includes receiving from the CE device at least a default gateway associated with the CE device.

13. The server of claim 9, wherein the logic includes using information uploaded by the probing utility to compile home network statistics.

14. A method for networking a PC with a non-PC CE device in a home, comprising:
receiving over the Internet from the CE device at least its address;
receiving from the PC at least its network address; and
providing networking information to both the CE device and the PC to enable them to communicate with each other in a home network.

15. The method of claim 14, comprising receiving from the CE device its serial number and receiving from the PC the serial number of the CE device, and based at least in part on the serial number, correlating the CE device to the PC.

16. The method of claim 14, comprising receiving configuration choices from the PC over the Internet.

17. The method of claim 16, comprising receiving network parameters associated with the PC over the Internet.

18. The method of claim 17, comprising providing the PC, over the Internet, with an IP address of the CE device and at least one connection parameter.

19. The method of claim 18, comprising providing the CE device, over the Internet, with an IP address of the PC and at least one configuration parameter.

20. The method of claim 14, wherein the addresses are IP addresses or MAC addresses.
